(19) United States
(12) Patent Application Publication
(10) Pub. No.: US 2024/0140774 A1
(43) Pub. Date: May 2, 2024

(54) Beverage preparation machine with a locking means and a coupling element, and beverage preparation system

(71) Applicant: Freezio AG, Amriswil (CH)

(72) Inventor: Gabriel Stösser, Langrickenbach (CH)

(21) Appl. No.: 18/278,265

(22) PCT Filed: Mar. 11, 2022
(86) PCT No.: PCT/EP2022/056328

§ 371 Date: Aug. 22, 2023

(30) Foreign Application Priority Data
Mar. 11, 2021 (DE) 10 2021 202 397.5

(51) Int. Cl. B67D 1/00; B67D 1/04; B67D 1/08

(52) U.S. Cl. CPC B67D 1/0079; B67D 1/0021; B67D 1/0046; B67D 1/0066; B67D 1/0418; B67D 1/0801; B67D 2001/0811; B67D 2001/0814; B67D 1/0888

(57) ABSTRACT

The invention relates to a beverage preparation machine (1), in particular a dispenser, for preparing a beverage using a cartridge system consisting of a cartridge (10), which has a beverage substance in a reservoir (11), and a cartridge receiving area (14), which is connected to the cartridge (10) and has at least one liquid supply opening (19), a mixing chamber, and a beverage outlet (15), wherein the beverage preparation machine (1) comprises a cartridge mounting (4), in particular a cartridge mounting which has a balcony-like design, the cartridge system can be inserted into the cartridge mounting (4), and the beverage preparation machine (1) comprises a liquid reservoir (3), a liquid thermal conditioning system for thermally conditioning a liquid from the liquid reservoir (3), a coupling element (21) for selectively coupling between the liquid thermal conditioning system and the liquid supply opening (19) of the cartridge receiving area (14), and a controller for controlling the beverage preparation machine (1). The coupling element (21) has at least one liquid line (22), and the cartridge mounting (4) has at least one locking means (8) which is designed to reversibly lock the cartridge system in the cartridge mounting (4). The locking means (8) can be reversibly converted from an unlocked position into a locked position, and the locking means (8) interacts with the cartridge system in the locked position in a form- and/or force-fitting manner.

### PRIOR ART

The invention relates to a beverage preparation machine for preparing a beverage by means of a cartridge system.

Such beverage preparation machines are known in principle from the prior art, for example from EP 2 017 221 A1 and WO 96/36556 A1, and are used for the production of beverages from pre-portioned cartridges. The production of beverages with such beverage preparation machines is extremely convenient for users since they only have to insert a cartridge into the beverage preparation machine and initiate a start procedure. The beverage preparation machine, also referred to as a dispenser, then takes over the production of the beverage in a fully automated manner, i.e. in particular that the, preferably liquid, beverage substance is mixed with a predetermined quantity of liquid, in particular cold and carbonated water, and passed into a drinking vessel. In this way, it is possible, in particular, to produce mixed beverages significantly more easily, more quickly and with less effort for users. Users can choose from a multiplicity of different cartridges containing different beverage substances, enabling them to produce different beverages as desired.

It is important with such beverage preparation machines that the cartridge is held securely in the beverage preparation machine such that, on the one hand, there are no leaks and, on the other hand, however, no recontamination occurs. In particular, it has to be ensured that a user does not remove the cartridge from the beverage preparation machine before the preparation of the beverage is complete, since otherwise liquid can escape from the beverage preparation machine in an uncontrolled manner. Furthermore, it is crucial for leak-free operation that there is a reliable coupling between the liquid supply of the beverage preparation machine and the cartridge.

### DISCLOSURE OF THE INVENTION

It was therefore the object of the present invention to provide a beverage preparation machine that meets these requirements. In particular, leak-free beverage production without recontamination of components of the beverage preparation machine is intended to be made possible. At the same time, the beverage preparation machine is intended to offer a high level of operating convenience and to be able to be implemented cost-effectively.

The object is achieved with a beverage preparation machine as claimed in claim 1.

The statements relating to this subject matter of the present invention also apply equally to the other subject matter of the present invention and vice versa.

The present invention relates to a beverage preparation machine, in particular a dispenser, for preparing a beverage by means of a cartridge system consisting of a cartridge, which has a beverage substance in a reservoir, and of a cartridge receptacle, which is connected to the cartridge and has at least one liquid supply opening, a mixing chamber and a beverage outlet. The cartridge has a cavity as a reservoir in which the beverage substance is located. Said substrate is preferably liquid and in particular a concentrate and is mixed with a liquid, in particular water, to produce a beverage and is then collected in a container, preferably a drinking vessel, in particular a glass and/or a cup, which particularly preferably stands in a set-down region on a support, arranged below the cartridge holder, of the dispenser. The set-down region comprises in particular a liquid-collecting device. Said liquid-collecting device is used, for example, to collect residual liquid that drips from the beverage outlet and/or the liquid outlet, or if a user does not place a container or a drinking vessel in the set-down region in good time before the start of the preparation of the beverage, or does not position it correctly or removes it before the end of the preparation. The beverage substance preferably comprises liquid pre-mix ingredients for soft drinks, such as caffeinated, carbonated, fruity and/or sugary lemonades and/or juices, beer (mixed) drinks or other alcoholic or non-alcoholic (mixed) drinks. The cartridge preferably has a cartridge opening which is particularly preferably closed off by means of a sealing element, for example a sealing film, and is thereby separated from the mixing chamber of the cartridge receptacle. The cartridge receptacle is preferably firmly connected, in particular non-rotatably, to the cartridge in a connection region.

The beverage preparation machine comprises a cartridge holder, in particular of balcony-like design, wherein the cartridge system is insertable into the cartridge holder. Balcony-like preferably means that the cartridge holder protrudes laterally from a housing of the beverage preparation machine and has a substantially horizontal extent. The position of the cartridge holder from a support surface of the beverage preparation machine is preferably arranged at a height which corresponds to 20-90% of the total height of the beverage preparation machine, particularly preferably 40-80%, very particularly preferably 50-70% and in particular essentially 60%. Particularly preferably, the cartridge holder is at least partially height-adjustable.

The beverage preparation machine preferably comprises a housing in which at least some of the components are completely or partially housed. The cartridge holder particularly preferably protrudes from said housing.

The beverage preparation machine also comprises a liquid reservoir and a liquid conditioning system for conditioning a liquid from the liquid reservoir. The liquid is preferably water. The liquid reservoir is particularly preferably a liquid tank which is very particularly preferably at least partially arranged in the housing of the beverage preparation machine. Partly means in particular that, for example, the liquid tank is arranged between a bottom surface and/or a cover of the housing, but an outer wall of the liquid tank is an outer wall of the beverage preparation machine. Alternatively or additionally, the beverage preparation machine comprises a connection to an external liquid supply network, for example a public water network. The beverage preparation machine particularly preferably comprises a liquid processing means, in particular a filter device, which is very particularly preferably arranged in the liquid tank such that the liquid has to flow from the liquid tank through the filter device before it leaves said tank. The liquid conditioning system extracts liquid from the liquid reservoir and conditions same. In the present case, this preferably comprises controlling the temperature, in particular cooling, and carbonating, i.e. adding carbon dioxide to the liquid. A person skilled in the art understands that controlling the temperature can easily also comprise heating the liquid in addition to or as an alternative to cooling, i.e. generally controlling the temperature of the liquid to a predetermined temperature.

The liquid conditioning system makes the liquid conditioned in this way, that is to say in particular cooled and carbonated, available to the cartridge system via a coupling element, where it is mixed with the beverage substance in the mixing chamber.

In order to move the liquid from the liquid reservoir in the direction of the cartridge system, the beverage preparation machine, in particular the liquid conditioning system, comprises at least one pump for pumping the liquid. The pump is preferably an oscillating pump, but diaphragm pumps and/or rotary pumps can also be used as an alternative or in addition. A person skilled in the art will understand that pumps are standardized components that are typically purchased and that the specifications of the pump are chosen to meet the needs of the beverage preparation machine while minimizing costs. It is therefore provided, according to a preferred embodiment, that the beverage preparation machine comprises at least one first and one second pump, which are preferably connected in parallel. The pumps are particularly preferably each operated in alternative phases of a wave-like activation. In this way, it is possible in a particularly advantageous manner to use two standardized pumps which together have the same output, instead of a pump designed and manufactured specifically for the beverage preparation machine. Of course, it is also possible in this way to operate three, four, five or more pumps. In particular, for example, two pumps that are connected in series can also be operated in parallel with two other pumps that are also connected in series. A person skilled in the art understands that, due to the space restrictions, however, a smallest possible number of pumps is desirable.

The beverage preparation machine, in particular the liquid conditioning system, preferably comprises at least one flow-measuring device, which is particularly preferably connected to the control device in order to make the measured values available thereto, with the control device being intended in particular to use these measured values in particular to control the pump. A flow-measuring device is very particularly preferably provided upstream of each pump.

The liquid conditioning system preferably comprises a compression refrigeration machine, an absorption refrigeration machine and/or a thermoelectric and/or thermoacoustic refrigeration machine. A compression refrigeration machine is particularly preferably used in the beverage preparation machine according to the invention. Such a compression refrigeration machine comprises at least one heat exchanger, a compressor, a condenser and a throttle, in particular a capillary tube and/or an expansion valve. Alternatively or additionally, the beverage preparation machine comprises a heating machine. Usually, however, it is desirable to provide a chilled beverage and therefore to cool the liquid. The heat exchanger is very particularly preferably an in-line heat exchanger. This means in particular that the heat exchanger is integrated in the liquid path, e.g. is formed around a liquid line. In this way, the installation space of the beverage preparation machine is advantageously used efficiently.

To create carbonated beverages, the liquid conditioning system comprises a carbon dioxide source, a metering device, and a mixing device. In particular, commercially available carbon dioxide cartridges or cylinders are suitable as the carbon dioxide source. Alternatively or additionally, the beverage preparation machine can also have connection options to an external carbon dioxide source.

Furthermore, the liquid conditioning system comprises at least one compensator for reducing the pressure of the carbonated liquid. In this way, a reliable and controlled dispensing of the liquid is achieved in an advantageous manner, and therefore the carbonated liquid, in particular, does not splash when it exits the beverage preparation machine. A predetermined pressure of the liquid can be set by means of the compensator. The compensator is preferably provided to be controllable for this purpose. The compensator is particularly preferably adjusted at the factory, i.e. during manufacture of the beverage preparation machine; alternatively or additionally, the compensator is adjustable by a user and/or the control device. As a result, the quality of the beverage produced can advantageously be increased. For example, such a compensator comprises a substantially conically shaped line section in which a longitudinally displaceable conical insert is arranged. Adjusting the conical insert thus changes the gap between the insert and the line, which changes the pressure accordingly. Such a compensator is an in-line compensator, i.e. a compensator integrated in the liquid line. The pressure upstream of the compensator is preferably 6-14 bar, particularly preferably 8-12 bar, in particular 10 bar, and downstream of the compensator the pressure very particularly preferably substantially corresponds to the ambient pressure, i.e. approximately 1 bar.

In order to introduce the conditioned liquid into the cartridge system, the beverage preparation machine comprises a coupling element for selectively coupling between the liquid conditioning system and the liquid supply opening of the cartridge receptacle. The coupling element can consequently couple selectively to the cartridge system and for this purpose comprises at least one liquid line.

Finally, the beverage preparation machine comprises a control device for controlling the beverage preparation machine, in particular at least some of the aforementioned components, such as the pump, the liquid conditioning system and/or the coupling element. The control device preferably initiates the preparation of a beverage and in particular also ends same, for example by stopping the liquid supply.

According to the invention, it is now provided that the cartridge holder has at least one locking means which is provided for reversibly locking the cartridge system in the cartridge holder, the locking means being able to be reversibly transferred from an unlocked position into a locked position, and the locking means in the locked position interacting with the cartridge system with a form fit and/or force fit. The locking means is consequently actuated and, as a result, locks the cartridge system in the cartridge holder. That is to say, a user cannot remove the cartridge system from the beverage preparation machine without first transferring the locking means into the unlocked position. In this way, it is ensured in a particularly advantageous manner that no continuous drawing off of liquid can take place without a cartridge system being correctly inserted into the cartridge holder.

According to a preferred embodiment or further subject matter of the present invention, it is provided that the coupling element can be transferred from a retracted position into an extended position, wherein, in the extended position, there is an, in particular tight, fluid connection between the liquid supply opening of the cartridge receptacle and the liquid line of the coupling element. The coupling element is thus provided to be movable, in particular relative to the cartridge system used in the cartridge holder, with coupling to the cartridge system, in particular the cartridge receptacle, being undertaken in the extended position.

This advantageously achieves the effect that the cartridge system can be inserted into the cartridge holder without damaging the liquid-carrying parts of the beverage preparation machine and a reliable and secure coupling can then be produced. In particular, it is possible in this way to ensure a liquid-tight coupling between the cartridge system and the beverage preparation machine.

According to a preferred embodiment of the present invention, it is provided that the cartridge holder has an, in particular centrally arranged, recess into which the cartridge system, in particular the cartridge receptacle, is at least partially insertable. The cartridge holder is thus preferably designed substantially in the shape of a torus. The recess is particularly preferably designed to taper downward such that the cartridge system is held securely in the recess, but cannot slip out of the cartridge holder downward. Very particularly preferably, the recess has a substantially circular cross section in a horizontal plane, in particular the same cross section as the cartridge receptacle. Substantially is intended here to mean that there may be deviations from the circular shape in certain areas. For example, the cartridge holder and/or the cartridge receptacle are/is preferably flat in the region provided for coupling to the coupling element. In this way, on the one hand, a simpler, tight coupling is made possible, since this is easier to achieve between flat surfaces, and, on the other hand, correct orientation between the cartridge system, in particular the cartridge receptacle and the beverage preparation machine, is ensured, which in turn ensures a reliable, liquid-tight coupling between the cartridge receptacle and the coupling element.

According to a preferred embodiment of the present invention, it is provided that the locking means is designed to be rotatable about an, in particular horizontally arranged, axis. The locking means is particularly preferably an elongate element which is rotatable at one end, for example a lower end, about the, in particular horizontal, axis. This enables a particularly simple and reliable movement between the unlocked and the locked position, since the upper, movable end can cover a sufficiently large distance to securely lock the cartridge system inserted into the recess.

According to a preferred embodiment of the present invention, it is provided that the cartridge holder has a plurality of, preferably at least three, locking means which are particularly preferably distributed around the circumference of the recess, in particular uniformly. This advantageously ensures that a sufficiently secure locking of the cartridge system in the cartridge holder is always ensured. In particular, any incorrect positioning of the cartridge system can be advantageously compensated for by the locking means distributed along the circumference of the recess.

According to a preferred embodiment of the present invention, it is provided that the at least one locking means is hook-shaped at least in sections, the hook-shaped section being provided to lockingly interact with a section of the cartridge system, in particular a flange of the cartridge. The cartridge and/or the cartridge receptacle therefore preferably have/has at least one region which protrudes laterally, in particular horizontally, and behind which the locking means can engage. Since the recess is preferably provided in a tapering manner and the locking means according to this embodiment prevent a movement upward, the cartridge system is advantageously securely held in the cartridge holder despite the simple design of the locking means. The hook shape also enables the forces to be dissipated in a particularly advantageous manner, even if a user pulls upward on the cartridge system with a certain force. The at least one locking means particularly preferably comprises at least one predetermined breaking point in order to avoid damage to the cartridge holder and/or the beverage preparation machine in the situation explained above.

According to a preferred embodiment of the present invention, it is provided that the at least one locking means is pretensioned in the direction of the unlocked position, in particular by a spring. Such spring pretensioning is a particularly simple, proven and reliable way to ensure that the locking means is in the unlocked position so that a cartridge system can be easily inserted into the cartridge holder.

According to a preferred embodiment of the present invention, it is provided that the beverage preparation machine, in particular the cartridge holder, has an operating element, in particular a hand lever, the operating element being adjustable between a first position and a second position, wherein, in the first position of the operating element, the locking means is in the unlocked position and, in the second position of the operating element, the locking means is in the locked position, the operating element being configured in such a way that, during the adjustment from the first position to the second position, the locking means is transferred from the unlocked position into the locked position. The hand lever preferably protrudes horizontally laterally from the cartridge holder. Provision is particularly preferably made for the operating element to be rotatable about a vertical axis which runs in particular centrally through the recess of the cartridge holder, preferably in an angular range of 10 to 180 degrees, particularly preferably in an angular range from 40-120 degrees, very particularly preferably in an angular range of approximately 90 degrees. A user can thus advantageously bring about the transfer of the locking means into the locked position or, after the beverage has been prepared, into the unlocked position. A person skilled in the art will understand that the aforementioned vertical axis coincides in particular with a longitudinal axis of the cartridge system when the cartridge system is properly inserted into the cartridge holder. The cartridge holder preferably comprises an indicator element to show the user that the locked and/or unlocked position has been correctly reached. This can be a marking, for example, the user having to bring the operating element into a flush position with the marking. Alternatively or additionally, the indicator element is provided to emit an acoustic and/or visual signal in order to indicate correct locking and/or unlocking. The configuration of the operating element as a pivotable lever is a particularly simple variant that is operable intuitively by the user. In particular, the different angular positions enable the user to immediately recognize whether the locking means is in the unlocked or locked position.

Alternatively, it is also conceivable for a user just to signal to the control device via an operating element, such as a physical and/or virtual button, that a cartridge system is inserted, and the transfer of the locking means into the locked position is undertaken automatically, in particular via a motorized drive.

According to a preferred embodiment of the present invention, it is provided that the operating element is connected, in particular integrally, to a slotted guide, the slotted guide being designed so as, during an adjustment, in particular a rotation about the vertical axis, to transfer the locking means from the unlocked into the locked position. In this way, a particularly simple and reliable transfer, in particular of a plurality of locking means at the same time, can be achieved. In the event that the slotted guide is formed integrally with the operating element, the complexity of the beverage preparation machine is also advantageously reduced, since there are fewer components. If a plurality of locking means are provided, the slotted guide preferably has a plurality of guides, in particular designed identically to one another, and therefore preferably all the locking means are moved simultaneously.

According to a preferred embodiment of the present invention, it is provided that the coupling element is pretensioned in the direction of the extended position, in particular by a spring. This has the effect in a particularly simple manner that the coupling element automatically assumes a coupling position, i.e. the extended position, unless a component of the beverage preparation machine explicitly prevents this. The force exerted by the spring also advantageously ensures a certain contact pressure between the liquid supply opening and the coupling element such that the tightness of the connection is increased.

According to a preferred embodiment of the present invention, it is provided that the operating element is connected, in particular integrally, to a slotted guide, the slotted guide being designed so as, during an adjustment, in particular a rotation around the vertical axis, to transfer the coupling element from the extended position into the retracted position. The coupling element preferably has a guide means which is provided to functionally interact with the slotted guide. The guide means is particularly preferably a projection, which is in particular formed integrally with the coupling element, the projection very particularly preferably resting with a contact surface on the slotted guide. The slotted guide interacting with the coupling element can be formed integrally with the slotted guide interacting with the locking means or can be manufactured separately and optionally connected to the slotted guide. The slotted guides are preferably different sections of a common slotted guide. In this particularly advantageous manner, the transfer of the locking means from the locked position into the unlocked position is linked simultaneously with the transfer of the coupling element from the extended position into the retracted position. After both movements have ended, the cartridge system can preferably be removed from the cartridge holder. A person skilled in the art understands that the movements of the coupling element and the locking means are brought about differently. Since the locking means is preferably pretensioned in the direction of the unlocked position, the slotted guide opens up the way for the locking means while the spring tension causes the movement of the locking means. In the case of the coupling element, this takes place in particular in the reverse manner. The spring tension here preferably causes pretensioning in the direction of the extended position, while the slotted guide actively moves the coupling element in the direction of the retracted position.

According to a preferred embodiment of the present invention, it is provided that the beverage preparation machine comprises a compressed air source, the compressed air source being configured to supply compressed air to the cartridge system, in particular to a compressed air supply opening of the cartridge receptacle, the coupling element also being configured for selective coupling between the compressed air source and the compressed air supply opening of the cartridge receptacle, and the coupling element having a compressed air line. The compressed air is used to transfer the beverage substance from the reservoir of the cartridge into the mixing chamber of the cartridge receptacle. For this purpose, the compressed air is introduced into the reservoir through a compressed air line, as a result of which, on the one hand, the production of negative pressure is avoided and, on the other hand, the beverage substance is preferably actively expelled by the compressed air. This advantageously ensures that the entire beverage substance is transferred out of the cartridge and advantageously shortens the beverage preparation time.

According to a preferred embodiment of the present invention, it is provided that, in the extended position, there is an, in particular tight, fluid connection between the compressed air supply opening of the cartridge receptacle and the compressed air line of the coupling element. In this case, said tight fluid connection is preferably established at the same time as the tight liquid connection between the liquid supply opening and the liquid line of the coupling element.

According to a preferred embodiment of the present invention, it is provided that the coupling element has a sealing means at least in a region intended for contacting the cartridge receptacle, the sealing means comprising an at least partially elastic material, in particular an elastic plastics material. The sealing means is particularly preferably provided as a coating. For example, the sealing means is sprayed onto the coupling element or applied in an in-mold process. The sealing means is very particularly preferably made from a material that is harmless in the food industry. In particular, the sealing means contains silicone. Such a sealing means advantageously ensures that there is always a tight fluid-carrying connection when the coupling element with the cartridge system inserted is in the extended position. A person skilled in the art understands that, of course, there is no sealing means in the outlet region of the liquid line and/or the compressed air line, and therefore the liquid flow and/or the compressed air flow can pass unhindered from the coupling element into the cartridge receptacle.

According to a preferred embodiment of the present invention, it is provided that the cartridge holder has at least one stop means which preferably interacts with a slotted guide, in particular the slotted guide explained previously, in such a way that the first position and/or the second position are/is defined as (an) end position(s). The stop means is particularly preferably an element which is firmly connected, in particular integrally, to the cartridge holder and which interacts with a form fit and/or a force fit with a guide in the slotted guide in the first and/or second position. The stop means is very particularly preferably designed in the manner of a pin. This ensures that the cartridge holder is not damaged by moving the operating element and/or the slotted guide beyond the first and/or the second position.

According to a preferred embodiment of the present invention, it is provided that the cartridge holder has a position detection means for detecting at least one position of the operating element and/or the slotted guide. The position detection means is particularly preferably a position switch or limit switch. The position detection means very particularly preferably comprises a light barrier and/or a proximity switch. In particular, the position detection means is arranged in such a way that it detects when the operating lever has reached the second position and/or when the locking means has reached the locked position. Alternatively or additionally, the position detection means or another position detection means is configured in such a way that it detects the extended position of the coupling means.

According to a preferred embodiment it is provided that the liquid line and preferably the compressed air line of the coupling element are rigid lines and are in particular provided integrally in the coupling element. Since the coupling element is preferably designed to be movable, at least one partially flexible line has to be arranged between the liquid conditioning system and the coupling element and/or between the compressed air source and the coupling element in order to compensate for the movement. However, the provision of rigid lines in the coupling element ensures reliable operation, since this ensures a constant orientation of the lines relative to the cartridge holder and therefore also to a cartridge system arranged therein. In addition, complex maintenance on the movable coupling element is precluded.

According to a preferred embodiment, it is provided that the beverage preparation machine, in particular the control device, is configured in such a way that preparation of a beverage, in particular a liquid supply and/or a compressed air supply through the coupling element, is only possible when the operating element is in the second position and/or the locking means is in the locked position. The control device is particularly preferably functionally connected to the position detection means such that preparation of a beverage can only be initiated when the position detection means has detected that the locking means has reached the locked position and/or that the control element has reached the second position. This ensures that incorrect operation of the beverage preparation machine is precluded.

The present invention furthermore relates to a beverage preparation system with a beverage preparation machine according to the invention and a cartridge system, wherein, for the preparation of a beverage, the cartridge system is insertable into the cartridge holder of the beverage preparation machine, the cartridge system comprising a cartridge, which comprises a reservoir filled with a beverage substance, and a cartridge receptacle, which is connectable to the cartridge in a connection region, wherein the cartridge has a cartridge opening, the cartridge opening being closed with a sealing element, in particular a sealing film, wherein the sealing element seals off the reservoir fluid-tightly from the cartridge receptacle, wherein the cartridge receptacle has a mixing chamber, which is connectable to the reservoir, and a liquid supply opening, which opens into the mixing chamber, for coupling to the liquid line of the coupling element such that a liquid is introducible into the mixing chamber, wherein the cartridge receptacle has a cartridge discharge device for transferring the beverage substance from the reservoir into the mixing chamber, the cartridge receptacle having a beverage outlet for discharging a beverage, which has been produced by mixing the liquid with the beverage substance, from the mixing chamber.

The statements relating to this subject matter of the present invention also apply equally to the other subject matter of the present invention and vice versa.

The beverage preparation system according to the invention is particularly flexible and hygienic, since there is no recontamination of parts of the beverage preparation machine, and drawing off of liquid after premature removal of the cartridge system is excluded, since the locking means holds the cartridge system securely in the cartridge holder and preferably the control device prevents drawing off of liquid in the unlocked position of the locking means.

With regard to the configuration of the cartridge receptacle and the cartridge, reference is made to the application, with reference being made to the disclosure content thereof, in particular with regard to possible configurations of the cartridge receptacle, and the relevant disclosure content being incorporated into the present disclosure.

The cartridge and/or the cartridge receptacle is preferably produced from plastic, in particular by an (in)molding and/or a blow molding process. The cartridge has a side wall which has, for example, a round, rectangular, square, conical or oval cross section. A base is generally provided, in particular integrally, at one end of the side wall. The side wall and the bottom region span a cavity which forms the reservoir in which a beverage substance, in particular in liquid form, is provided. At the other end of the wall region there is a connection region by which the cartridge is connected to the cartridge receptacle.

Alternatively, it is also conceivable that the cartridge is at least partially manufactured from glass. In this case, an intermediate piece is preferably provided between the cartridge receptacle and the cartridge. Such an intermediate piece acts in particular as an adapter. Thus, conventional, commercially available bottles (made of glass or other materials) are also usable in the cartridge system. With regard to such an intermediate piece and in particular a cartridge which is usable with such an intermediate piece, reference is made to the applicant's application DE102020213332.8, to the disclosure content of which, in particular with regard to such an intermediate piece, reference is made, the relevant disclosure content being incorporated into the present disclosure.

The cartridge preferably comprises a cartridge neck which has at least one flange, in particular at least two flanges which are spaced apart from one another. The at least one flange particularly preferably protrudes from the connection region and protrudes at an angle, very particularly preferably at a right angle, from a wall region of the connection region. When the cartridge system is correctly inserted into the cartridge holder, the flange is aligned in particular horizontally. Preferably, the flange is manufactured from solid material, i.e. is not hollow. In particular, the flange is injection molded and/or manufactured integrally with the cartridge, in particular the side wall of the cartridge and/or the cartridge neck. Owing to the fact that it is preferably substantially the cartridge receptacle that creates the connection to the cartridge holder, the cartridge can be designed to be flexible. For example, the cartridge can have different diameters and/or different axial lengths in order to accommodate different volumes of beverage substance. The beverage substance is preferably in liquid form, particularly as a syrup and/or a beverage concentrate. However, it is also conceivable for the cartridge holder to at least partially comprise supporting means for the cartridges, for example in the form of a stand-up collar.

The cartridge receptacle can be permanently connected to the cartridge or it can be a replacement part that is removed from the cartridge after use and connected to a new cartridge. The cartridge receptacle is particularly preferably connected, in particular clipped, to the cartridge with a form fit and/or a force fit. The flange on the cartridge preferably interacts sealingly with the cartridge receptacle. For this purpose, the circumference of the flange can engage, for example, in a groove in the cartridge receptacle. Said flange/groove connection can also serve as a force fit to prevent the cartridge from being displaced relative to the cartridge receptacle during production of a beverage or food and the connection between the cartridge and cartridge receptacle from becoming leaky.

As previously explained, it is preferred if the locking means interacts in a locking manner with the at least one flange. Alternatively or additionally, a fastening means is provided in the side wall region of the cartridge and/or in the region of the cartridge neck. In this case, the at least one locking means interacts in a locking manner with the fastening means as an alternative or in addition to the flange. The fastening means can be a groove, for example, in which the locking means engages.

The cartridge has a cartridge opening, the cartridge opening being closed with a sealing element, in particular a sealing film, and the sealing element sealing off the reservoir fluid-tightly with respect to the cartridge receptacle. The sealing element is preferably fastened to the at least one flange, in particular sealed against the latter. The sealing film particularly preferably comprises a single-layer or multi-layer membrane. It is crucial that the sealing element, on the one hand, closes the reservoir liquid-tightly such that even in the preferred arrangement according to the invention, in which the cartridge system is inserted into the cartridge holder with the cartridge opening facing downward, the beverage substance cannot leave the reservoir when the sealing element is closed. On the other hand, the sealing element has to be able to be opened in a targeted, local and simple manner by the cartridge discharge device such that the beverage substance can be transferred in particular quickly and completely into the mixing chamber of the cartridge receptacle.

According to a further preferred embodiment of the present invention, it is provided that the beverage preparation machine has an identifier detector for reading a product identification identifier on the cartridge and/or the cartridge receptacle, with the identifier detector preferably being arranged above and/or behind the cartridge holder, in particular in the housing of the beverage preparation machine. A pane that is transparent at least for the radiation used and in particular also in the optical range is preferably arranged in front of the identifier detector. The product identification identifier is preferably embedded in a barcode, an RFID code, a QR code, a data matrix code, a color code, a hologram code or the like. Automatic reading of the product identification identifier is thus advantageously possible. The identifier detector comprises in particular an optical sensor, such as a CCD camera, which automatically reads the barcode or QR code or data matrix code when the cartridge system is inserted into the beverage preparation machine. Alternatively, the identifier detector comprises a transmitting and receiving antenna for automatically reading the RFID codes. Alternatively, it would be conceivable for the product identification identifier to also be embedded in other automatically readable computer chips. In the context of the present invention, the term QR code comprises in particular any data matrix code. In this respect, the terms QR code and data matrix code are used synonymously. Alternatively or additionally, it would also be conceivable for the product identification identifier to comprise a barcode, a dot code, a binary code, a Morse code, a Braille character code (Braille) or the like. The code can also be embedded in a three-dimensional structure, such as a relief. The product identification identifier comprises in particular what is referred to as the product identification number, in particular a Universal Product Code (UPC), a European Article Number (EAN), a GS1 code, a Global Trade Item Number (GTIN) or the like. In this way, no new code system needs to be introduced for this purpose. In particular, the product identification identifier falls under the GS1 standard. The product identification identifier is preferably printed directly on the cartridge and/or the cartridge receptacle, glued and/or incorporated into the surface of the cartridge, for example by (laser) engraving, stamping or directly during the manufacture of the cartridge. Alternatively, it would also be conceivable for the cartridge to be at least partially encased in a cover, for example a sleeve, on which the product identification identifier is arranged. The cover can also be glued or welded to the cartridge and/or the cartridge receptacle. The cover or sleeve could be produced from a plastics film, a textile or paper.

According to a preferred embodiment of the present invention, it is provided that the cartridge discharge device comprises a spike guide and a piercing spike, which is mounted displaceably within the spike guide, in particular in one direction, wherein the piercing spike is displaceable by an actuator element of the beverage preparation machine between a retracted position, in which the piercing spike is spaced apart from the sealing element, and an extended position, in which the piercing spike pierces the sealing element and projects into the reservoir. A cartridge discharge device designed in this way is particularly advantageous because the piercing spike permits a targeted and simple opening of the sealing element and thus a precisely controllable transfer of the beverage substance from the reservoir into the mixing chamber.

According to a preferred embodiment, it is provided that the beverage preparation machine comprises an, in particular motorized, drive, for the actuator element. The drive is particularly preferably coupled to the operating element, in particular to the hand lever. The drive is very particularly preferably arranged in the housing of the beverage preparation machine and functionally connected to the actuator element via a deflection mechanism. The actuator element of the beverage preparation machine is preferably controllable by the control device. More details in this regard are provided in the applicant's application entitled “Beverage preparation machine with a drive and beverage preparation system” from the same filing date, to the disclosure content of which, in particular with regard to possible embodiments of the actuator element and/or drive, reference is made, with the relevant disclosure content being incorporated into the present disclosure.

According to a preferred embodiment, it is provided that the cartridge receptacle, in particular the cartridge discharge device, comprises a compressed air supply opening for coupling to the compressed air line of the coupling element, a compressed air outlet and a compressed air line which extends from the compressed air supply opening to the compressed air outlet, wherein the coupling element is designed to introduce compressed air from the compressed air source of the beverage preparation machine through the compressed air supply opening into the compressed air line, the compressed air line preferably being integrated in the piercing spike, the cartridge discharge device being particularly preferably designed in such a way that, when the piercing spike is in the extended position, the beverage substance can be transferred by the compressed air from the reservoir into the mixing chamber. A person skilled in the art understands that this embodiment is preferably implemented together with the embodiment according to which the beverage preparation machine comprises a compressed air source. In this case, the compressed air source provides the compressed air which—particularly only when the piercing spike is in the extended position—is introduced into the reservoir through the compressed air line of the piercing spike and via the compressed air outlet, thus assisting the transfer of the beverage substance from the reservoir into the mixing chamber. If the cartridge system is correctly arranged in the cartridge holder and in particular locked via at least one locking means, the compressed air supply opening of the cartridge receptacle can be brought into fluid connection with a compressed air line of the beverage preparation machine. The beverage preparation machine is preferably configured in such a way that compressed air is provided, in particular immediately after a fluid-tight connection has been established between the compressed air supply opening of the cartridge receptacle and the compressed air line of the coupling element. Since the compressed air line is thus under pressure, in particular immediately after a connection has been established, it is advantageously precluded that beverage substance can enter the beverage preparation machine through the compressed air line, thereby preventing cross-contamination and further improving the hygiene of the beverage preparation machine.

The piercing spike preferably has at least one, preferably a plurality of, indentations and/or bulges, in particular channels, on its outer circumference, which serve as a drain for the beverage substance. The number and size of the indentations and/or bulges preferably depends on the viscosity of the beverage substance. The outer wall of the piercing spike is thus preferably provided with at least one side channel for directing the beverage substance toward the mixing chamber in the extended position when the sealing element is pierced. The substrate can then flow past the sealing element in the direction of the mixing chamber through the side channel which is formed laterally on the piercing spike and in particular extends substantially vertically. The at least one side channel is designed in particular in the form of a groove which is open on one side. It is conceivable that in particular the cross section of the side channel is also adapted to the viscosity of the beverage substance, and therefore the at least one side channel controls or limits the flow of the beverage substance in the direction of the mixing chamber. In the case of high viscosity, a plurality of side channels and/or side channels with a larger cross section are used, while in the case of lower viscosity fewer side channels or side channels with a smaller cross section are provided. For each cartridge or each beverage substance there is therefore preferably a suitable cartridge receptacle, in particular a suitable cartridge discharge device.

The present invention furthermore also relates to a method for preparing a beverage with a beverage preparation system according to the invention, characterized by the following steps:
inserting a cartridge system consisting of a cartridge and a cartridge receptacle into the cartridge holder,
transferring the locking means from the unlocked position into the locked position,
transferring the coupling element from the retracted position into the extended position to establish a connection between the liquid line of the coupling element and the fluid supply opening of the cartridge holder and preferably to establish a connection between the compressed air line of the coupling element and the compressed air supply opening of the cartridge receptacle,
transferring the beverage substance from the reservoir of the cartridge into the mixing chamber of the cartridge receptacle, in particular by feeding compressed air into the reservoir,
introducing a liquid into the mixing chamber of the cartridge receptacle through the coupling element,
discharging the beverage, which is produced in the mixing chamber by mixing the beverage substance with the liquid, through the beverage outlet.

The statements relating to this subject matter of the present invention also apply equally to the other subject matter of the present invention and vice versa.

The method according to the invention affords the same advantages as the beverage preparation machine according to the invention and the beverage preparation system according to the invention, i.e. in particular simple, hygienic and reliable preparation of a beverage, in which operating errors and/or contamination due to liquid escaping unintentionally are excluded.

In particular, the steps of transferring the beverage substance from the reservoir of the cartridge into the mixing chamber of the cartridge receptacle and introducing a liquid into the mixing chamber of the cartridge receptacle occur substantially simultaneously. Alternatively, the chronological sequence of the steps are controllable by the control device, in particular taking into account product information read by the identifier detector. Thus, for example, the time, the speed, the degree of carbonation and/or the temperature of the liquid introduced are/is controllable depending on the beverage substance, in particular the viscosity thereof. This is particularly advantageous in particular in the case of highly viscous beverage substances, e.g. a syrup.

According to a preferred embodiment of the present invention, it is provided that the step of transferring the beverage substance from the reservoir of the cartridge into the mixing chamber of the cartridge receptacle comprises actuating the cartridge discharge device, in particular by transferring the piercing spike from the retracted position into the extended position, thus causing the sealing element to be perforated. For this purpose, an actuator element of the beverage preparation machine is particularly preferably activated and displaces the piercing spike into the extended position. The actuator element is very particularly preferably activated by a drive, which is in particular controlled by the control device and/or is motorized. Alternatively or additionally, the actuator element is connected directly or indirectly to the operating element, for example via a triggering mechanism. For example, it is possible for a user to actuate and/or release the actuator element by transferring the hand lever into the second position such that the control device receives the command for activating or actuating the actuator element via actuation of another operating element, for example a pushbutton switch, a physical and/or virtual button. This further simplifies the method for preparation of a beverage.

According to a preferred embodiment of the present invention, it is provided that the step of transferring the locking means from the unlocked position into the locked position comprises transferring the operating element from the first position into the second position, and/or wherein the step of transferring the coupling element from the retracted position into the extended position comprises transferring the operating element from the first position into the second position. Advantageously, the user can thus lock the cartridge system in the cartridge holder in a simple and comprehensible manner or, in particular, unlock it again after the beverage has been prepared.

According to a preferred embodiment of the present invention, the liquid is temperature controlled, in particular cooled, and/or carbonated by the liquid conditioning system before being introduced into the mixing chamber.

According to a further preferred embodiment of the present invention, it is provided that before, during or after the insertion of the cartridge system into the cartridge holder and/or the feeding of compressed air into the cartridge and/or the introduction of the liquid into the mixing chamber, a product identification identifier is read by the identifier detector. The product identification identifier which is read is evaluated preferably by the control device, with the compressed air and/or the liquid being fed in particularly preferably only if the product identification identifier can be verified by the control device. In this way, it is ensured that the beverage preparation machine can only be put into operation with cartridge systems that are known or certified and/or compatible for the beverage preparation machine, and therefore damage to the beverage preparation machine or a risk of injury to the user due to the accidental use of the wrong cartridge systems, which, for example, cannot withstand the pressure, are avoided.

It is also conceivable that the properties of the liquid and in particular the time profile of the volume flow, the total volume, the pressure, the delivery pauses, the temperature and/or the degree of carbonation of the liquid fed in are controlled depending on the (verified) product identification identifier. Alternatively or additionally, the properties of the compressed air fed in and in particular the time profile of the volume flow, the total volume, the delivery pauses, and/or the pressure of the compressed air fed in are controlled depending on the (verified) product identification identifier. The ratio between the volume flow of the liquid and the volume flow of the compressed air is also very particularly preferably controlled depending on the (verified) product identification identifier. In particular, all the parameters and/or variables of the beverage production process that can be set by the beverage preparation machine are embedded in the product identification identifier, and therefore the beverage preparation machine receives all the information from the cartridge system that is necessary or at least helpful or recommended for the production of the respective beverage. It is also conceivable that this information is stored in an internal memory of the beverage preparation machine and retrieved using the product identification identifier for the respective cartridge system and used to control the subsequent beverage production process as soon as the presence of this cartridge system in the cartridge holder is detected.

### DESCRIPTION OF THE FIGURES

The invention will be explained below with reference to FIGS. 1 to 13. These explanations are merely by way of example and do not restrict the general inventive concept. The explanations apply equally to the beverage preparation machine according to the invention, the beverage preparation system according to the invention and the method according to the invention.

FIG. 1 shows a beverage preparation machine according to an exemplary embodiment of the present invention.

FIG. 2 shows a perspective detailed view of a beverage preparation machine according to an exemplary embodiment of the present invention.

FIGS. 3-5 show schematic sectional views of successive steps of a method according to an exemplary embodiment of the present invention.

FIG. 6 shows a perspective detailed view of a cartridge holder according to an exemplary embodiment of the present invention.

FIG. 7 shows a schematic plan view of a cartridge holder according to an exemplary embodiment of the present invention.

FIG. 8 shows a schematic plan view of a cartridge holder with an operating element in the first position according to an exemplary embodiment of the present invention.

FIG. 9 shows a schematic plan view of a cartridge holder with an operating element in the first position according to an exemplary embodiment of the present invention.

FIG. 10 shows a schematic plan view of a cartridge holder with an operating element in the second position according to an exemplary embodiment of the present invention.

FIG. 11 shows a schematic plan view of a cartridge holder with an operating element in the second position according to an exemplary embodiment of the present invention.

FIG. 12 shows a perspective detailed view of a cartridge holder according to an exemplary embodiment of the present invention.

FIG. 13 shows a schematic plan view of a cartridge holder according to an exemplary embodiment of the present invention.

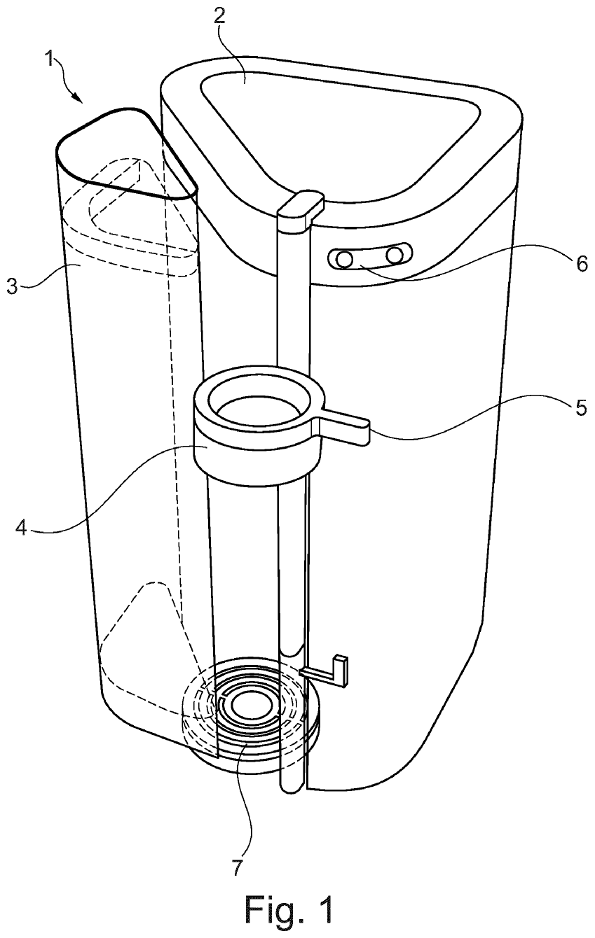

FIG. 1 illustrates a beverage preparation machine 1 according to an exemplary embodiment of the present invention. FIG. 1 in particular shows one possible form of appearance of the beverage preparation machine 1. Of course, other shapings are also possible. The beverage preparation machine 1 comprises a housing 2 in which most of the functional components, such as a liquid conditioning system, a coupling element 21, a power connection, a control device implemented, for example, on a printed circuit board, and the like are arranged. The beverage preparation machine 1 comprises a power connection (not shown here) to an external power supply network and/or an internal energy storage device, for example a storage battery that is sufficiently dimensioned for a plurality of beverage preparation processes.

Furthermore, the beverage preparation machine 1 here comprises a liquid reservoir 3 which, as illustrated, is preferably designed as a water tank. The liquid reservoir 3 can be arranged on the outside, as shown, and connected to the housing 2 merely via a bottom region. However, it is also possible for the liquid reservoir 3 to be entirely or partially arranged within the housing 2. For example, the liquid reservoir 3 is removable from the housing 2 for filling and/or is fillable via a cover access in the housing. Such a liquid reservoir 3 can additionally comprise means for processing the liquid. In the simplest case, such a means consists of a filter element, in particular for adjusting the calcium content of the liquid.

Additional, optional operating elements 6 are arranged here in the upper region of the housing 2. These are designed, for example, as pushbutton switches, but may take any form, such as a touchscreen with virtual keys, physical buttons, virtual or physical rotary switches, etc. A user can use said additional operating elements 6, for example, to start or initiate, and preferably also interrupt, preparation of a beverage. Furthermore, for example, operating elements 6 can be provided for selecting a liquid volume and/or a degree of carbonation.

A cartridge holder 4 is arranged projecting laterally from the housing 2. Said cartridge holder 4 is the central location of the preparation of a beverage. A cartridge system consisting of a cartridge 10 and a cartridge receptacle 14, which is connected to the cartridge, can be arranged in the cartridge holder 4, which has a central recess for this purpose. The recess is preferably provided such that it tapers downward, and therefore a cartridge system is insertable into the cartridge holder 4 from above, but cannot slip downward out of the latter. In the present case, the cartridge holder 4 is approximately in the shape of a circular ring, but the only decisive factor is a recess matching the cartridge receptacle 14, and the outer shape of the cartridge holder 4 and the dimensions thereof are however substantially freely selectable. However, the balcony-like shape shown here is preferred in principle, since the resulting filigree and free-floating impression is particularly esthetically pleasing. The recess preferably interacts at least in sections with the cartridge receptacle 14 with a form fit. Said form fit is particularly preferably further assisted by the fact that the cartridge holder 4 has an opening for a beverage outlet 15 of the cartridge receptacle 14 at its lower end, and therefore the cartridge receptacle 14 is only correctly insertable into the cartridge holder 4 in one orientation in such a manner that the cartridge system is lockable in the cartridge holder 4.

A set-down region 7 is provided in particular in a vertical line below the cartridge holder, said set-down region here comprising a set-down grid and preferably a liquid-collecting device. For the preparation of a beverage, a container, for example a drinking vessel, such as a beaker, a cup or a glass, can be placed on the set-down grid. If the user positions the drinking vessel too late in the set-down region or aligns it incorrectly, or if dripping occurs, the beverage and/or liquid can pass through the set-down grid into the liquid-collecting device arranged underneath and can then be removed.

The cartridge holder 4 is provided here at about 60% of the total height of the beverage preparation machine 1. However, the cartridge holder 4 can also be provided higher, for example at a height of between 60% and 100%, preferably between 70% and 90% and in particular at about 80% of the overall height, or lower, for example at a height of between 20% and 60%, preferably between 30% and 50% and in particular at about 40% of the overall height of the beverage preparation machine. The cartridge holder 4 is particularly preferably height-adjustable. In this way, the cartridge holder 4 can be adjusted to the height of the respective drinking vessel such that the beverage does not drop into the drinking vessel from too great a height. In this way, splashing of the beverage can be prevented.

According to the preferred embodiment illustrated here, an operating element in the form of a hand lever 5 is provided on the cartridge holder. A user can pivot the hand lever 5 between a first position and a second position about a vertical axis running centrally through the recess. As will also be explained in more detail below, this serves to lock the cartridge system in the cartridge holder 4 such that the cartridge system cannot be removed from the cartridge holder 4.

The cartridge holder 4 and in particular the hand lever 5 is preferably coupled to the control device of the beverage preparation machine 1 in such a way that it is not possible to start the preparation of a beverage if the hand lever 5 is in the first position, which corresponds to an unlocked position.

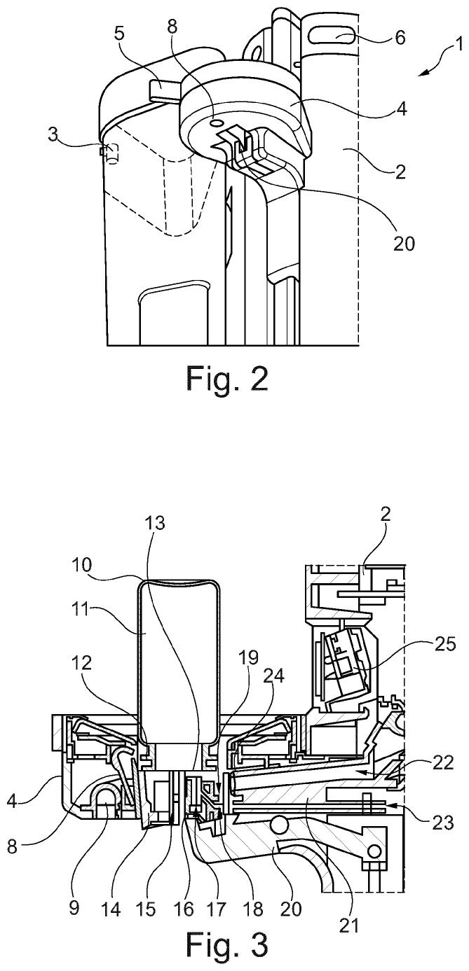

FIG. 2 illustrates a perspective detailed view of a beverage preparation machine 1 according to an exemplary embodiment of the present invention. The illustrated embodiment is similar to the embodiment discussed in conjunction with FIG. 1 and therefore reference is made in principle to the statements in this regard.

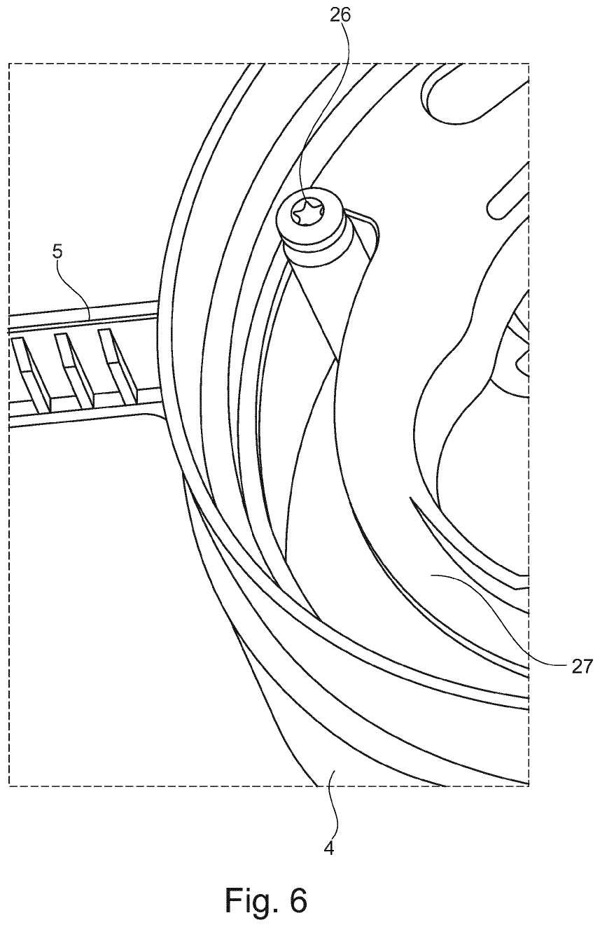

Only a detail of the beverage preparation machine 1 can now be seen here. The liquid reservoir 3, in which a filter cartridge can be seen here by way of example, can be seen on the left. Furthermore, additional operating elements 6 are indicated at the upper edge of the housing 2. The focus here is on the cartridge holder 4 and the hand lever 5. The hand lever is formed here integrally with a peripheral collar of the cartridge holder 4 and is pivotable, for example, from the first position shown on the left by about 90° to the right into a second position. The first position corresponds to an open position in which a user can insert a cartridge system consisting of a cartridge 10 and a cartridge receptacle 14 connected thereto. The second position corresponds to a locked position in which the cartridge system is locked in the cartridge holder 4 such that it is no longer removable from the cartridge holder 4 (without being destroyed). The way in which this locking is achieved will be explained in more detail below and in particular with reference to FIGS. 6-11.

The aforementioned angular range of approximately 90°, in which the hand lever 5 is pivotable, is by way of example. An angular range of 60°, 120° or 180° is thus also conceivable. However, an angular range of approximately 90°, in particular between 60° and 120°, is particularly advantageous since in this case the position of the hand lever 5 can be easily and directly recognized by the user, and therefore the user can advantageously see at a glance whether a locked or an unlocked position is present. This can be further reinforced by appropriate markings and/or info-graphics or info-symbols on the cartridge holder 4. For example, an unlocked lock is shown on the outside of the cartridge holder 4 in the region of the first position and a locked lock is shown in the second position. This signals to the user in a known manner, on the one hand, which position is currently present and, on the other hand, as far as which position the hand lever is pivotable and/or has to be pivoted.

An outlet can be seen on the underside of the cartridge holder 4 in the front region. This is an optional additional dedicated liquid outlet 9 via which in particular temperature-controlled and/or carbonated liquid can be dispensed separately and/or in addition to the beverage. More details in this regard are explained in the applicant's parallel application entitled “Beverage preparation machine with a liquid outlet and beverage preparation system” from the same filing date, with express reference being made to the relevant disclosure content with regard to the design of the liquid outlet 9 and said reference being incorporated in the disclosure content of the present application.

An actuator element 20 is furthermore indicated. The latter is preferably designed as a rocker arm and, as shown, lies mostly inside the housing of the cartridge holder 4 and the beverage preparation machine 1. One end of said actuator element 20, which, when activated, actuates a cartridge discharge device of the cartridge receptacle 14, is visible here.

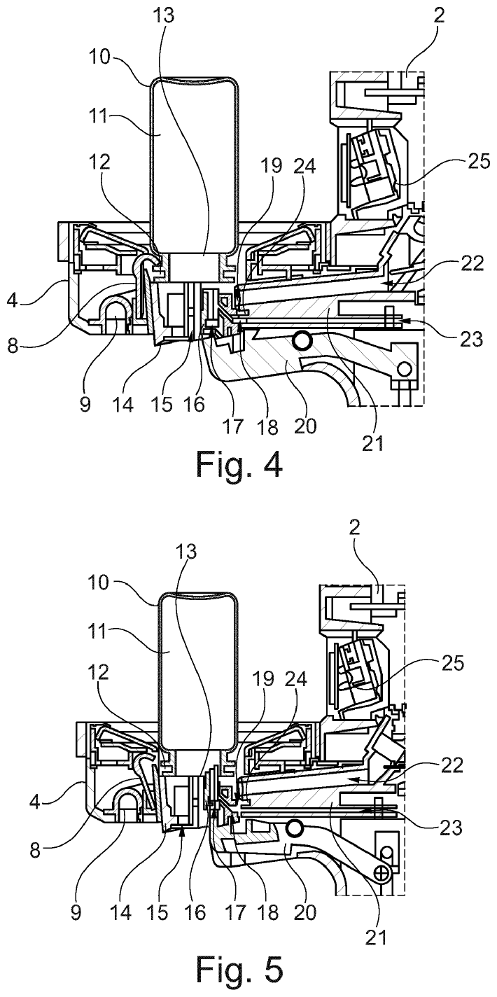

FIGS. 3-5 show schematic sectional views of successive steps of a method according to an exemplary embodiment of the present invention. Only a detail of the beverage preparation machine 1 with the cartridge holder 4 is shown here. The beverage preparation machine 1 can be designed in accordance with the embodiments explained in conjunction with the previous figures, for which reason reference is made to the statements in this regard. In addition, with reference to FIG. 3, the beverage preparation system and the components thereof will be explained in detail below.

In contrast to the previously discussed embodiments, an optional identifier detector 25 is additionally provided here. The latter is arranged, for example, behind a pane, which is transparent to the radiation used, in the housing 2 of the beverage preparation machine 1 and is aligned in such a way that it can read a product identification identifier arranged on the outside of the cartridge 10 and/or the cartridge receptacle 14. In principle, any type of detector can be used, but an optical sensor and/or an RFID sensor are/is preferred. Additionally or alternatively, the control device and/or the identifier detector 25 can comprise a communication module for communication with an external resource, such as a remote server. In addition or as an alternative to the product identification identifier, further and/or supplementary information relating to the beverage substance and/or preparation parameters can be retrieved there. The control device particularly preferably controls the parameters of the preparation of a beverage using the product identification identifier determined by the identifier detector 25. Such parameters include, for example, parameters relating to the liquid, such as temperature, degree of carbonation, volume and/or speed of the liquid flow, parameters relating to the compressed air, such as pressure, volume and/or speed of the compressed air, or dynamic parameters, such as the time of liquid supply and/or compressed air supply or courses of the aforementioned parameters. For example, a beverage preparation cycle can include pauses in the liquid supply and/or compressed air supply and/or different pressures and/or volumes over time.

In the cross section, the dedicated liquid outlet 9, which is guided substantially in the shape of a semi-torus around the recess, can be clearly seen. It is also indicated that the actuator element 20, which according to the embodiment shown here is in the form of a rocker arm that is tiltable about a horizontal axis, can be connected in the beverage preparation machine 1 to a drive, in particular a motorized drive, which is preferably controllable by the control device.

The beverage preparation machine 1 also comprises components that are not shown here for the sake of clarity. The beverage preparation machine 1 thus comprises a liquid conditioning system. The latter is arranged downstream of the liquid reservoir 3 and upstream of the cartridge holder 4. Such a liquid conditioning system is provided to condition the liquid, in particular to control its temperature and/or to carbonate same, before it is supplied to the cartridge system.

The liquid conditioning system comprises, for example, inter alia, at least one (hydraulic) pump for transporting the liquid. In principle, it is also possible to use a plurality of pumps, for example connected in parallel, if the pump capacity required cannot be easily achieved with one pump. A flow meter is preferably assigned to the at least one pump. The flow meter provides the control device with the required measured values for controlling the pump. The pump preferably pumps the liquid to a temperature control device. In the present case, this is, for example, a compression refrigeration machine, which cools the liquid, in particular as the water, to a drinking temperature that is perceived as pleasant, for example approximately 3-8° C. Such a compression refrigeration machine comprises in a known manner at least one heat exchanger, a compressor, a condenser and a throttle, in particular a capillary tube and/or an expansion valve. The heat exchanger is preferably designed as an in-line heat exchanger, i.e. the liquid is cooled as it flows through the liquid line. Alternatively, the beverage preparation machine 1 can also comprise a container in which the temperature of the water is controlled.

In addition, the beverage preparation machine 1 in the present case comprises a carbonation system, which preferably comprises, inter alia, a carbon dioxide source, in particular in the form of commercially available cylinders made of metal. The latter are interchangeably used and connected in the beverage preparation machine 1. Since such cylinders are under high pressure, the carbonation system comprises a pressure reduction device downstream of the carbon dioxide source and a metering device downstream of said pressure reduction device. The metering device is preferably controllable by the control device and/or by a user and is used to set the desired degree of carbonation for the liquid.

Furthermore, the carbonation system preferably comprises a mixing device downstream of the metering device, said mixing device being in particular in the form of an in-line mixing device, i.e. the carbonation of the liquid takes place while the liquid flows through the liquid line and in particular not when it is stationary. Preferably, the mixing device is arranged downstream of the liquid temperature control system such that already temperature-controlled, in particular cooled, liquid is carbonated in the mixing device.

Here, the beverage preparation machine 1 also comprises a compressed air source. The latter, in its simplest form, can consist in ambient air being sucked in from outside the beverage preparation machine 1, said air then being pressurized by a suitable pump. In this case, the (air) pump can also be considered to be part of the compressed air source. Alternatively or additionally, the beverage preparation machine 1 comprises a connection to an external compressed air supply network, which makes compressed air available to the beverage preparation machine 1. Compressed air is supplied to the cartridge system from the compressed air source via the coupling element 21.

The beverage preparation machine 1 preferably also comprises, in particular downstream of the mixing device and upstream of the coupling element 21, at least one compensator for reducing the pressure of the carbonated liquid, and particularly preferably at least one valve. Such a valve is preferred in particular in conjunction with the additional liquid outlet 9. In this way, a reliable and controlled dispensing of the liquid is achieved in an advantageous manner, and therefore the carbonated liquid, in particular, does not splash at the exit. In particular, a predetermined pressure of the liquid can be set by means of the compensator. The compensator is preferably provided to be controllable for this purpose. The compensator is particularly preferably adjusted at the factory, i.e. during manufacture of the beverage preparation machine; alternatively or additionally, the compensator is adjustable by a user and/or the control device. For example, such a compensator comprises a substantially conically shaped line section in which a longitudinally displaceable conical insert is arranged. Adjusting the conical insert thus changes the gap between the insert and the line, which changes the pressure accordingly. Such a compensator is an in-line compensator. The pressure upstream of the compensator is preferably 6-14 bar, particularly preferably 8-12 bar, in particular 10 bar, and downstream of the compensator the pressure very particularly preferably substantially corresponds to the ambient pressure, i.e. approximately 1 bar. With regard to more detailed explanations of the compensator and/or the valve, reference is made to the applicant's parallel application entitled “Beverage preparation machine with a liquid outlet and beverage preparation system” from the same filing date, the disclosure content of which regarding the compensator and a possible valve is hereby referred to and the disclosure content thereof is incorporated into the present disclosure.

FIG. 3 illustrates the state shortly after inserting the cartridge system into the cartridge holder 4. The cartridge system consists of a cartridge 10 which comprises a side wall and a base region which together define a cavity which serves as a reservoir 11 for an, in particular liquid, beverage substance. The side wall can substantially have any desired cross section. However, a square or a (circular) round cross section is preferred. The cartridge 10 further comprises a cartridge neck which surrounds a cartridge opening. The cartridge opening is closed air-tightly and/or liquid-tightly by a sealing element 13, preferably a sealing film, for example a single-layer or multi-layer membrane made from a plastics material and/or a metallic material, such as aluminum or an aluminum alloy. The beverage substance is thus enclosed in the reservoir as far as an opening of the sealing element 13. The cartridge 10 is preferably manufactured from a plastics material, for example by spraying or injection molding or by a blow molding technique. The same applies particularly preferably to the cartridge receptacle 14.

The cartridge neck preferably has a smaller diameter than the side wall, i.e. it constitutes a constriction. Furthermore, it is preferred if the cartridge neck and/or the cartridge opening comprises at least one flange 12, particularly preferably two flanges spaced vertically apart from one another. In particular, it is provided that the sealing element 13 is connected to at least one flange 12, in particular in an integrally bonded manner. For example, the sealing element 13 can be sealed to a flange 12 circumferentially surrounding the cartridge opening.

A connection region, via which the cartridge 10 is connected with a form fit, force fit and/or in an integrally bonded and in particular non-rotatable manner to a cartridge receptacle 14, which is in particular substantially cap-shaped, is provided in the region of the cartridge neck.

The cartridge receptacle 14 is preferably clipped to the at least one peripheral flange 12, for example. In the present case, purely by way of example, an embodiment is shown according to which the cartridge 10 has two flanges 12 which are substantially identical but are vertically spaced apart from one another. The cartridge receptacle 14 is connected in particular to the lower flange 12 in the drawing with a force fit and/or form fit. The second flange 12 interacts in a locking manner here with a locking means 8 in a manner yet to be explained.

The cartridge receptacle 14 has a mixing chamber and at least one liquid supply opening 19, with, in particular carbonated and/or cooled, liquid supplied via the liquid supply opening 19 through the beverage preparation machine 1 being mixed in the mixing chamber with the beverage substance from the reservoir 11. The mixing results in a (mixed) beverage, which is then dispensed directly through a beverage outlet 15 of the cartridge receptacle 14 into a drinking vessel arranged underneath. As a result, the beverage does not come into contact with any components of the beverage preparation machine 1, and therefore any cross-contamination is avoided in a particularly hygienic manner. The cartridge receptacle 14 optionally additionally has a dedicated gas outlet in order to discharge gas released during the mixing from the cartridge receptacle 14. This is described in more detail in the applicant's application DE 102021200070.3, to the disclosure content of which reference is expressly made with regard to the design of the cartridge receptacle 14 and in particular of the gas outlet, and the disclosure of which is incorporated in the disclosure content of the present application.

The cartridge receptacle 14 also has at least one cartridge discharge device. In the present case, the latter is designed by way of example as a piercing spike 16 mounted so as to be displaceable in the vertical direction in a spike guide. The piercing spike 16 is preferably in the form of a plastics part and particularly preferably in the form of a plastics injection molded part. The piercing spike 16 can be transferred from a retracted position into an extended position by an actuator element 20 of the beverage preparation machine 1. In the extended position, said piercing spike pierces the sealing element 13 and thus ensures a fluidic connection between the reservoir 11 and the mixing chamber. The beverage preparation machine 1, and in particular the control device, thus determines the time at which the beverage is prepared, since, on the one hand, it causes the liquid to be supplied to the mixing chamber and, on the other hand, it activates the actuator element which actuates the cartridge discharge device and thus ensures that the beverage substance is transferred from the reservoir 11 into the mixing chamber.

In order to assist the transfer of the beverage substance, the piercing spike 16 has an internal compressed air line 17. The cartridge receptacle 14 has a compressed air supply opening 18 here below the liquid supply opening 19. If the cartridge receptacle 14 is therefore correctly arranged in the cartridge holder 4, the cartridge receptacle 14 is coupled to the beverage preparation machine 1 in such a way that it can introduce liquid through the liquid supply opening 19 into the mixing chamber and can provide compressed air at the compressed air supply opening 18. In particular, only in the extended position of the piercing spike 16 is the compressed air line 17 aligned directly or indirectly with the compressed air supply opening 18, for example via a compressed air line provided in the cartridge receptacle 14. At the end of the piercing spike 16 that protrudes in the direction of the cartridge 10, the latter has a compressed air outlet which, in the extended position, projects into the reservoir 11 in particular.

According to a particularly preferred embodiment, the piercing spike 16 has depressions, in particular channel-like depressions, on its outside, which extend substantially vertically according to the orientation shown here. The beverage substance can flow from the reservoir 11 into the mixing chamber via said depressions as soon as the sealing element 13 has been pierced. For example, the channel-like depressions are in the form of grooves which are open on one side, with the cross section and/or the number of depressions preferably being adapted to the viscosity of the beverage substance.

So that liquid and compressed air can be supplied safely and reliably to the cartridge receptacle 14, the beverage preparation machine 1 comprises, according to the invention, a coupling element 21 which can be transferred from a retracted position, which is shown here, into an extended position (cf. FIG. 4). In the extended position, the coupling element 21 establishes a fluid-tight coupling between the liquid conditioning system of the beverage preparation machine 1 and the liquid supply opening 19 of the cartridge receptacle 14.

Owing to the coupling element 21 being spaced apart from the cartridge receptacle 14 in the retracted position, it is ensured that the coupling element 21 is not damaged when the cartridge system is inserted. In addition, a fluid-tight coupling is ensured by the transfer into the extended position.

The coupling element 21 preferably has a sealing means 24, which is formed here, for example, as an elastic material, for example a material containing silicone, in the region of the tip of the coupling element 21, in particular at least in the region in which there is contact with the cartridge receptacle 14. As a result, the fluid tightness between the coupling element 21 and the cartridge receptacle 14 is further improved in an advantageous manner.

According to the preferred embodiment illustrated here, the coupling element 21 is a rigid element which internally has an, in particular integrally formed, liquid line 22, and an, in particular integrally formed, compressed air line 23. In the present case, said lines are arranged at an angle to one another, with the compressed air line 23 running substantially horizontally. In principle, it is preferred if the liquid line 22 slopes slightly in the direction of flow since this facilitates the complete drainage of the liquid and thus advantageously prevents the beverage preparation machine 1 from dripping. A person skilled in the art will understand immediately that this is not required for the compressed air line 23. Nevertheless, the precise arrangement of the liquid line 22 and/or the compressed air line 23 depends primarily on the arrangement of the fluid-carrying components in the beverage preparation machine 1. Furthermore, a person skilled in the art understands that, for example, between a compressed air source of the beverage preparation machine 1 and the compressed air line 23 of the coupling element 21 and/or between the liquid conditioning system and the liquid line 22 of the coupling element 21, a line that is flexible at least in sections is provided in order to compensate for the movement of the coupling element 21 between the retracted position and the extended position.

In FIG. 3, as already stated, the cartridge system is therefore inserted into the cartridge holder 4 in the correct orientation, but not yet locked. The piercing spike 16 is still in the retracted position, as is the coupling element 21.

In FIG. 4 a user has now pivoted the hand lever 5, which is formed integrally here with an element surrounding the cartridge holder 4 in the manner of a flange, from the first position about the vertical axis of rotation running parallel to the longitudinal axis of the cartridge into the second position, for example by approximately 90°. By means of a slotted guide 27, which is explained in more detail below in conjunction with FIGS. 6-13, three hook-like locking means 8 are pivoted in the direction of the recess, i.e. radially inward, such that they engage above the flange 12 of the cartridge 10 and thereby lock the latter with a form fit and/or force fit in the cartridge holder 4. The three locking means 8 are preferably of identical design and are arranged uniformly along the circumference of the recess. The upper end of the locking means 8 is hook-like, in particular rounded. At least one locking means 8 is provided according to the invention, but a higher number, such as three here, improves the locking, and therefore even greater forces can be absorbed. This prevents the user from removing the cartridge system from the cartridge holder while the beverage is being prepared, i.e. when the locking means 8 is in the locked position. The locking means 8 particularly preferably have at least one predetermined breaking point such that, although the cartridge system is prevented from being inadvertently removed prematurely, removal by force is possible, in order to avoid damage to the beverage preparation machine 1. The slotted guide makes it possible in a simple manner for all of the locking means 8 to be actuated simultaneously.

At their lower end, the locking means 8 are preferably pretensioned outward by means of a spring 28, i.e. in the direction of the unlocked position. This means that, as soon as the user moves the hand lever 5 back again in the direction of the first position, the locking means 8 slide back into the unlocked position along the slotted guide 27 by means of the spring 28.

Furthermore, it is preferred if the coupling element 21 is also pretensioned into the extended position by means of a spring 28′, with the coupling element 21 being guided by a further slotted guide 27′, which is very particularly preferably not identical to the slotted guide 27 assigned to the locking means 8, but is in particular formed integrally therewith. The movement of the hand lever 5 from the first into the second position thus advantageously simultaneously moves the locking means 8 into the locked position and the coupling element 21, assisted by the spring 28′, into the extended position. Conversely, when the cartridge holder 4 is unlocked, pivoting of the hand lever 5 from the second position into the first position causes the locking means 8, assisted by the springs 28, to be transferred into the unlocked position and the coupling element 21 into the retracted position.

In FIG. 4, the locking means 8 are thus in the locked position and the coupling element 21 in the extended position. The liquid line 22 of the coupling element 21 is aligned with the liquid supply opening 19 of the cartridge receptacle 14 and is connected thereto liquid-tightly by the sealing means 24. Similarly, the compressed air line 23 of the coupling element 21 is aligned with the compressed air supply opening 18 of the cartridge receptacle 14 and is connected thereto air-tightly by the sealing means 24. Compressed air is preferably already present in this position. However, since the piercing spike 16 is in the retracted position, the compressed air does not yet enter the compressed air line 17 and consequently does not exit from the compressed air outlet opening of the piercing spike 16 either. In the position shown here, the beverage preparation machine 1 is ready for preparing a beverage.

FIG. 5 now shows the state immediately after the beverage has been prepared. The control device has preferably previously activated a drive which actuates the actuator element 20. As a result, it is pivoted about the fixed horizontal tilting axis such that an end designed in particular as a ram contacts the piercing spike 16 and displaces the latter upward in the spike guide into the extended position. On the way to the extended position, the piercing spike 16 pierces the sealing element 13 and the beverage substance begins to run between the piercing spike 16 and the sealing element 13, in particular via the abovementioned, optional, channels of the piercing spike 16, into the mixing chamber. As soon as the piercing spike 16 has assumed the extended position, the compressed air line 17 integrated in the piercing spike 16 is aligned with the compressed air supply opening 18 or the compressed air line, arranged inbetween, of the cartridge holder 14. The compressed air is now introduced through the piercing spike 16 into the reservoir 11 and, on the one hand, prevents the creation of a negative pressure there and at the same time assists the transfer of the, under some circumstances highly viscous, beverage substance from the reservoir 11 into the mixing chamber. The flow of the beverage substance into the mixing chamber can consequently be in particular accelerated and/or controlled in a targeted manner by the compressed air. For example, the pressure in the cartridge 10 or the reservoir 11, and thus the volume flow of the beverage substance, can be adapted to the volume flow of the liquid in order to optimize the formation of a beverage. This may be of interest in particular when the volume flow of the liquid is controlled or regulated in a targeted manner in order to influence the frothing. The volume flow of the beverage substance is then preferably adapted to the volume flow of the liquid. In the mixing chamber, the beverage substance is mixed with the, in particular cooled and carbonated, liquid, thereby forming the beverage. The latter exits via the beverage outlet 15 into the drinking vessel arranged underneath.

Optionally, before, during, after and/or instead of the preparation of a beverage, liquid, in particular temperature-controlled and/or carbonated liquid, can be added to the drinking vessel via the liquid outlet 9. This can be advantageous if, for example, a user wants a more diluted beverage than a beverage preparation stored in the beverage preparation machine 1 or the user would like only to obtain chilled and/or carbonated liquid.

After the beverage has been prepared, the user can transfer the hand lever 5 back into the first position. The springs 28 cause the locking means 8, as illustrated in FIG. 5, to be transferred back into the unlocked position in a manner guided by the slotted guide 27. In a departure from the illustration selected here, the coupling element 21 is preferably also transferred into the retracted position at the same time by the slotted guide 27′.

The cartridge system is now empty and can be removed from the cartridge holder 4. The beverage preparation machine 1 is now ready for a new beverage preparation cycle.

FIG. 6 illustrates a perspective detailed view of a cartridge holder 4 according to an exemplary embodiment of the present invention. A horizontal section is shown here. The embodiment illustrated here substantially corresponds to the previously explained embodiments, which is why reference is made to the statements in this regard. The hand lever 5, which is connected integrally to a collar-like element which forms the upper end of the cartridge holder 4, can be seen here on the left. Preferably, the slotted guide 27 is also formed integrally with this element and thus with the hand lever 5. This simplifies the structure, since only one element is required and no deflection mechanism is required to transfer the movement from the hand lever 5 to the slotted guide 27.

The slotted guide 27 has a plurality of sections here. A curved section of the slotted guide 27, which interacts with the locking means 8, is visible on the right edge of the image. A simple guide, which interacts with a stop means 26 of the cartridge holder 4 to limit the movement of the hand lever 5 and/or of the slotted guide 27, is visible in the center of the image. The stop means 26 is designed here, for example, as a pin formed integrally with the cartridge holder. Said pin forms a stop for guiding the slotted guide 27 such that further rotation about the vertical axis of rotation is not possible, with the position of the hand lever 5 corresponding to the first or second position when the stop means 26 limits the rotation. Consequently, the first and the second position are defined by the stop means 26. Since the forces are absorbed by the stop means 26, damage to the locking means 8 as a result of excessive force is in particular avoided.

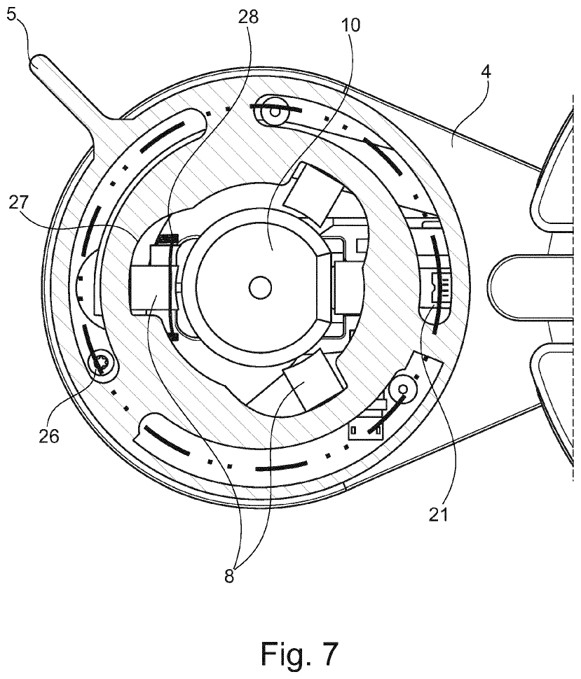

FIG. 7 illustrates a perspective plan view of a cartridge holder 4 according to an exemplary embodiment of the present invention. The embodiment illustrated here substantially corresponds to the previously explained embodiments, which is why reference is made to the statements in this regard. Here, in particular, the plan view of the detailed section illustrated in FIG. 6 is shown. It is easy to see how the slotted guide 27 is formed integrally with the hand lever 5. Guides for the one or more similar stop means 26 are provided on the outside, while the guides for the locking means 8 are arranged on the inside. As can be seen from the figure, the guides have a certain dead zone, i.e. a distance over which the position of the locking means 8 does not change. This is helpful in order that the cartridge holder 4 does not block the insertion or removal of a cartridge system even in the event of small movements and/or misalignments of the hand lever 5.

A cartridge 10 of an inserted cartridge system is visible in the center of the cartridge holder 4. Said cartridge has a side wall with a substantially circular cross section, but the side wall is flattened on one side, here the right-hand side in the figure. This asymmetry is preferably also present in the cartridge receptacle 14 and in particular also in the inner wall of the recess of the cartridge holder 4. This provides a guide which ensures that the cartridge system and in particular the liquid supply opening 19 and the compressed air supply opening 18 of the cartridge receptacle 14 are correctly oriented after insertion. A successful and reproducible coupling to the coupling element 21 is thus ensured.

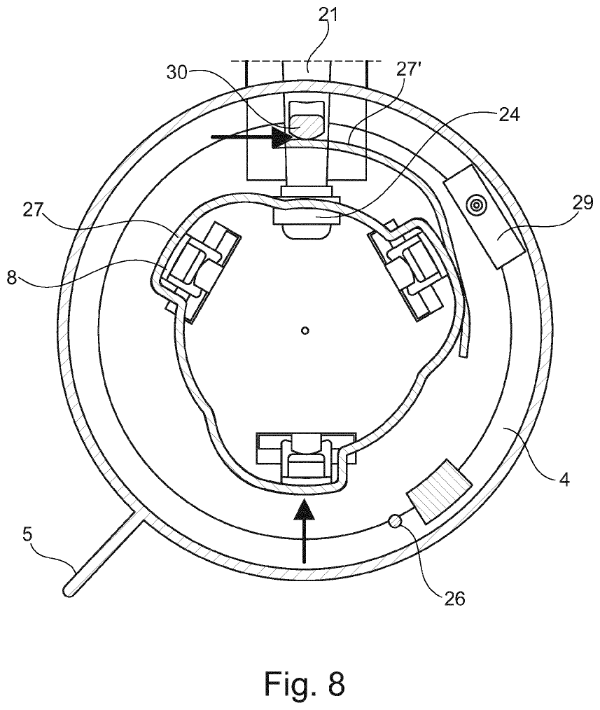

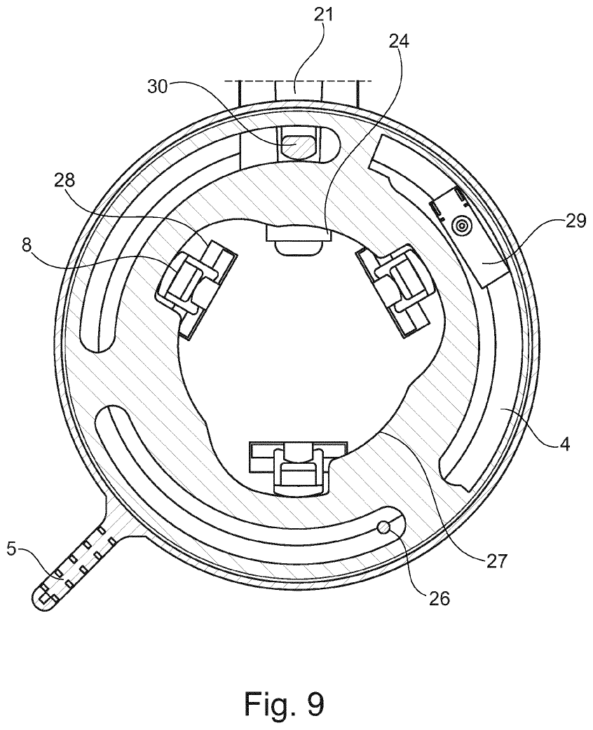

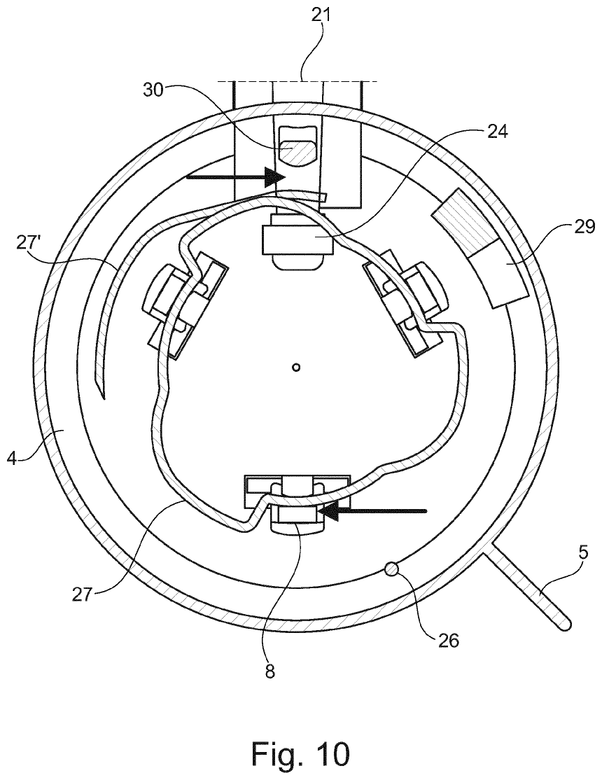

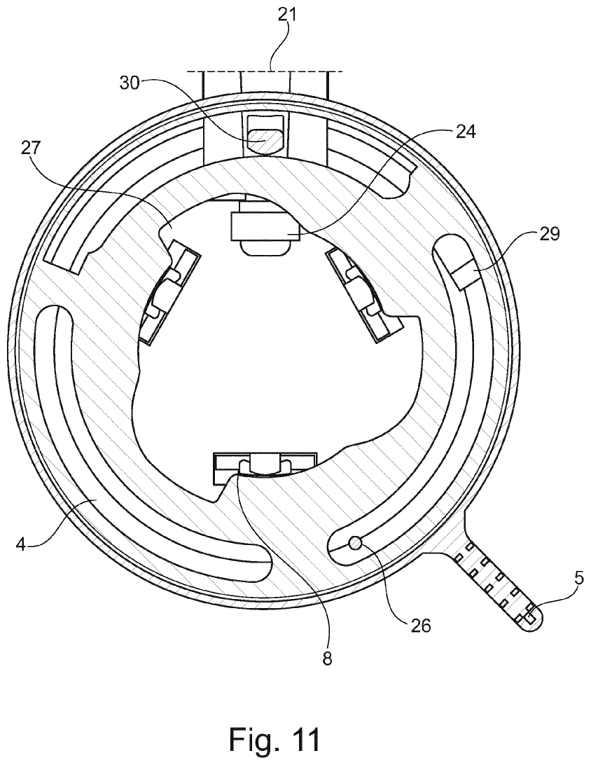

FIGS. 8 and 9 illustrate sectional views in different horizontal planes of a cartridge holder 4 in the first position. FIGS. 10 and 11 illustrate corresponding sectional views in the different horizontal planes of the cartridge holder 4 in the second position. The illustrated embodiment of the cartridge holder 4 in FIGS. 8-11 substantially corresponds to the previously explained embodiments, which is why reference is made to the statements in this regard.

FIG. 8 illustrates a schematic plan view of a cartridge holder 4 with an operating element, here a hand lever 5, in the first position according to an exemplary embodiment of the present invention. The sectional plane illustrated here is in particular deeper than that shown in the illustration in FIG. 9. On the one hand, the contours of the slotted guide 27 interacting with the three locking means 8 are illustrated here. Even if this is not evident from the present drawing, the slotted guide 27 is connected integrally to the hand lever 5 in the manner described above. The hand lever 5 is in the first position here. According to the embodiment illustrated here, the first position in relation to the orientation shown is reached at an angular position of the hand lever 5 of approximately 220°. This is advantageous because, on the one hand, the hand lever 5 is easily reachable by a user who is usually positioned in front of the beverage preparation machine 1 and, on the other hand, the first position is clearly recognizable.

Furthermore, the coupling element 21 is illustrated at the top edge of FIG. 8. Said coupling element has a projection 30 on its upper side, which interacts with a contour of a further slotted guide 27′ and thus holds the coupling element 21 in the retracted position against the spring force of a spring 28′, which is arranged in particular on the underside of the coupling element 21. It is particularly advantageous here if the slotted guide 27′ for the coupling element 21 is formed integrally with the slotted guide 27 for the locking means 8. This is also provided according to the embodiment illustrated here. In the right part of the figure it can be seen that the contours of the slotted guides 27, 27′ converge.

Furthermore, a limit switch 29 is provided here in the right-hand region of the cartridge holder 4, said limit switch determining the relative position of the slotted guides 27, 27′ and/or of the hand lever 5 via the collar-like element connected thereto. This relative position can then be transmitted to the control device. This determined position can be used, for example, to ensure that the control device only permits a beverage to be prepared when the limit switch 29 detects that the hand lever 5 is in the second position.

The sealing means 24, which is designed here as an elastic cover of the coupling element 21, can also be clearly seen in FIG. 8. The sealing means 24 preferably comprises a material that is hygienically harmless and approved for food preparation. The projection in the plane of the drawing of the previously explained stop means 26 can also be seen in the drawing. The locking means 8 also border on a stop of the contour of the slotted guide 27. However, so that the locking means 8 do not become damaged or jammed, a stop is formed by the stop means 26 and a corresponding guide in the slotted guide 27. The forces are thus introduced into the cartridge holder 4 via the stop means 26.

The illustration of FIG. 9 now substantially corresponds to that of FIG. 8, but a different, horizontal, sectional plane is selected. In particular, the sectional plane selected here lies above that of FIG. 8. As was explained in conjunction with FIG. 8, the projection 30 of the coupling element 21 interacts with a contour of a further slotted guide 27′, which, however, can certainly be formed integrally with the slotted guide 27. In particular, however, the projection does not interact with the guide which forms a stop for the stop means 26, even if this appears to be the case in FIG. 9. The integral design of the hand lever 5 and slotted guide 27 can again be clearly seen in this illustration. This is particularly advantageous since only one moving component is required.

FIG. 10 now shows the cartridge holder 4 of FIGS. 8 and 9 in the second position, which corresponds to the locked position of the locking means 8. The locking means 8 have been transferred into the locked position by the contour of the slotted guide 27 counter to the spring force exerted by the spring 28 on their base, at which they are connected to the cartridge holder 4 so as to be pivotable about a horizontal axis of rotation. At the same time, the contour of the other slotted guide 27′ has opened up the path for the coupling element 21 such that the latter is transferred into the extended position by the spring 28 arranged on the underside, in particular a spiral spring, and thereby couples to the cartridge receptacle 14. To illustrate these paths, both the coupling element 21 and the locking means 8 are illustrated in FIG. 10 in the unlocked or retracted position. However, a person skilled in the art will understand which position is actually taken up. The adjustment path of the coupling element 21 and of the locking means 8 can be seen in an advantageous manner, however, by the illustration selected.

FIG. 11, like FIG. 10, illustrates a schematic plan view of a cartridge holder 4 with the hand lever 5 in the second position according to an exemplary embodiment of the present invention. As in FIG. 10, the illustration of the coupling element 21 and of the locking means 8 is decoupled from the position of the hand lever. A person skilled in the art will understand that, in the second position, the coupling element 21 is actually moved further radially into the center of the recess and the rear surfaces of the upper region of the hook-like locking means 8 bear against the inside of the slotted guide 27. As in FIG. 8, the stop means 26 here forms a stop for the slotted guide 27, and therefore the second position is defined as the end position. This can be detected accordingly by the limit switch 29.

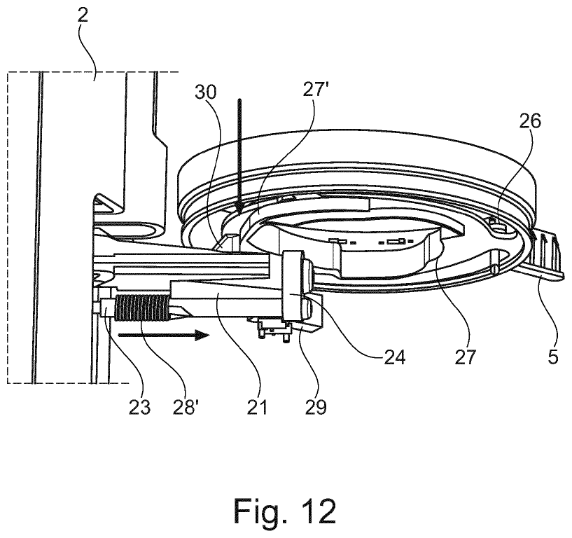

FIG. 12 illustrates a perspective detailed view of a cartridge holder 4 according to an exemplary embodiment of the present invention. The illustrated embodiment substantially corresponds to the previously described embodiments, and therefore reference is made to the previous statements. In order to make the internal components recognizable, an outer housing of the cartridge holder 4, such as shown in FIG. 2, is not illustrated here. The structure of the collar-like element which is connected to the hand lever 5, serves as the upper end of the cartridge holder 4 and is pivotable relative thereto between the first and second position, which are defined as end positions by the at least one stop means 26, can be seen. The hand lever, on the one hand, but also the slotted guides 27, 27′ and the guide for the stop means 26, on the other hand, are integral with said element. It can be seen from the drawing that the element is designed differently at the different height levels, with the plane of the slotted guide 27 interacting with the locking means 8 being higher, for example, than the plane of the slotted guide 27′ interacting with the coupling element 21.

In this illustration, the formation of the coupling element 21 can be clearly seen, including the projection 30 formed on the upper side. It can also be seen that here the spring 28′ is arranged around the compressed air line 23, this being particularly space-saving. The compressed air line 23 and the liquid line 22 are formed integrally in the coupling element 21, the coupling element 21 being manufactured from a plastics material, for example.

Furthermore, the sealing means 24, which is arranged at the tip of the coupling element 21, is clearly visible. The sealing means 24 and/or the coupling element 21 are/is rounded on the regions of the coupling element 21 intended for contact with the cartridge receptacle 14, in order to achieve a flexible and secure coupling. The embodiment of the coupling element 21 that is illustrated here remotely resembles a pistol barrel.

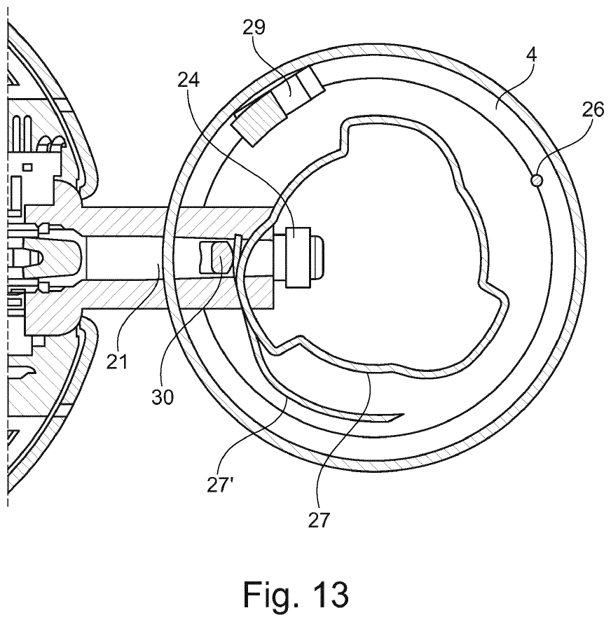

FIG. 13 illustrates a schematic top view of a cartridge holder 4 according to an exemplary embodiment of the present invention, the illustration corresponding in particular to a top view and a cross section in a horizontal cross section of the embodiment from FIG. 12. In particular, the illustrated embodiment substantially corresponds to that from FIG. 10, which is why reference is made to the statements in this regard, but here the coupling element 21 is illustrated in the correct, extended position.

### LIST OF REFERENCE SIGNS

1 beverage preparation machine
2 housing
3 liquid reservoir
4 cartridge holder
5 hand lever
6 additional operating elements
7 set-down region
8 locking means
9 additional liquid outlet
10 cartridge
11 reservoir
12 flange
13 sealing element
14 cartridge receptacle
15 beverage outlet
16 piercing spike
17 compressed air line (of the piercing spike)
18 compressed air supply opening
19 liquid supply opening
20 actuator element
21 coupling element
22 liquid line (of the coupling element)
23 compressed air line (of the coupling element)
24 sealing means
25 identifier detector
26 stop means
27, 27′ slotted guide
28, 28′ spring
29 limit switch
30 projection

1. A beverage preparation machine, in particular a dispenser, for
preparing a beverage by means of a cartridge system,
the cartridge system consisting of:
A) a cartridge, which has a beverage substance in a reservoir; and
B) a cartridge receptacle, which is connected to the cartridge and has:
at least one liquid supply opening;
a mixing chamber; and
a beverage outlet; and
the beverage preparation machine comprising:
a) a cartridge holder of balcony-like design;
b) a liquid reservoir;
c) a liquid conditioning system for conditioning a liquid from the liquid reservoir;
d) a coupling element for selective coupling between the liquid conditioning system and the liquid supply opening of the cartridge receptacle; and
e) a control device for controlling the beverage preparation machine;
wherein the cartridge system is insertable into the cartridge holder,
wherein the coupling element has at least one liquid line;
wherein the cartridge holder has at least one locking means which is provided for reversibly locking the cartridge system in the cartridge holder, the locking means being able to be reversibly transferred from an unlocked position into a locked position, the locking means in the locked position interacting with the cartridge system with a form fit and/or force fit.

2. The beverage preparation machine as claimed in claim 1, wherein the coupling element can be transferred from a retracted position into an extended position, wherein, in the extended position, there is a fluid connection between the liquid supply opening of the cartridge receptacle and the liquid line of the coupling element.

3. The beverage preparation machine as claimed in claim 1, wherein the cartridge holder has a centrally arranged, recess into which at least a portion of the cartridge system is at least partially insertable.

4. The beverage preparation machine as claimed in claim 1, wherein the locking means designed to be rotatable about an axis.

5. The beverage preparation machine as claimed in claim 1, wherein the cartridge holder has a plurality of locking means which are distributed around a circumference of a recess.

6. The beverage preparation machine as claimed in claim 1, wherein the at least one locking means is hook-shaped at least in sections, the hook-shaped section being provided to lockingly interact with a flange the cartridge.

7. The beverage preparation machine as claimed in claim 1, wherein the at least one locking means is pretensioned in a direction of the unlocked position by a spring.

8. The beverage preparation machine as claimed in claim 1, wherein the cartridge holder has an operating element, the operating element being adjustable between a first position and a second position, wherein, in the first position of the operating element, the locking means is in the unlocked position and, in the second position of the operating element, the locking means in the locked position, the operating element being configured in such a way that, during the adjustment from the first position to the second position, the locking means is transferred from the unlocked position into the locked position.

9. The beverage preparation machine as claimed in claim 8, wherein the operating element is rotatable about a vertical axis which runs centrally through a recess of the cartridge holder in an angular range of about 10 to about 180 degrees.

10. The beverage preparation machine as claimed in claim 8, wherein the operating element is connected to a slotted guide, the slotted guide being designed so as, during an adjustment, to transfer the locking means from the unlocked position into the locked position.

11. The beverage preparation machine as claimed in claim 1, wherein the coupling element is pretensioned in a direction of the extended position by a spring.

12. The beverage preparation machine as claimed in claim 8, wherein the operating element is connected to a slotted guide, the slotted guide being designed so as, during an adjustment, to transfer the coupling element from an extended position into a retracted position.

13. The beverage preparation machine as claimed in claim 1, wherein the beverage preparation machine comprises a compressed air source, the compressed air source being configured to supply compressed air to a compressed air supply opening of the cartridge receptacle; the coupling element also being configured for selective coupling between the compressed air source and the compressed air supply opening of the cartridge receptacle; and the coupling element having a compressed air line.

14. The beverage preparation machine as claimed in claim 2, wherein in the extended position, there is a tight fluid connection between a compressed air supply opening of the cartridge receptacle and a compressed air line of the coupling element.

15. The beverage preparation machine as claimed in claim 1, wherein the coupling element has a sealing means at least in a region intended for contacting the cartridge receptacle, the sealing means comprising an at least partially elastic material.

16. The beverage preparation machine as claimed in claim 8, wherein the cartridge holder has at least one stop means which interacts with a slotted guide in such a way that the first position and/or the second position are/is defined as (an) end position(s).

17. The beverage preparation machine as claimed in claim 1, wherein the liquid line and a compressed air line of the coupling element are rigid lines and are provided integrally in the coupling element.

18. The beverage preparation machine as claimed in claim 8, wherein the control device is configured in such a way that a liquid supply and/or a compressed air supply through the coupling element is only possible when the operating element is in the second position and/or the locking means is in the locked position.

19. The beverage preparation system with a beverage preparation machine as claimed in claim 1 and with a cartridge system, wherein, for the preparation of a beverage, the cartridge system is insertable into the cartridge holder of the beverage preparation machine, wherein the cartridge system comprises,
a cartridge which comprises a reservoir with a beverage substance, and
a cartridge receptacle, which is connectable to the cartridge in a connection region,
wherein the cartridge has a cartridge opening, the cartridge opening being closed with a sealing element,
wherein the sealing element seals off the reservoir fluid—tightly from the cartridge receptacle,
wherein the cartridge receptacle has a mixing chamber, which is connectable to the reservoir, and a liquid supply opening, which opens into the mixing chamber, for coupling to the liquid line of the coupling element such that a liquid is introducible into the mixing chamber,
wherein the cartridge receptacle has a cartridge discharge device for transferring the beverage substance from the reservoir into the mixing chamber, the cartridge receptacle having a beverage outlet for discharging a beverage, which has been produced by mixing the liquid with the beverage substance, from the mixing chamber.

20. The beverage preparation system as claimed in claim 19, wherein the cartridge discharge device comprises a spike guide and a piercing spike, which is mounted displaceably within the spike guide, wherein the piercing spike is displaceable by an actuator element of the beverage preparation machine between a retracted position, in which the piercing spike is spaced apart from the sealing element, and an extended position, in which the piercing spike pierces the sealing element and projects into the reservoir.

21. The beverage preparation system as claimed in claim 20, wherein the beverage preparation machine comprises a motorized drive for the actuator element.

22. The beverage preparation system as claimed in claim 19, wherein the cartridge receptacle comprises a compressed air supply opening for coupling to a compressed air line of the coupling element, a compressed air outlet and a compressed air line which extends from a compressed air supply opening to the compressed air outlet, wherein the coupling element is designed to introduce compressed air from compressed a air source of the beverage preparation machine through the compressed air supply opening into the compressed air line, the compressed air line being integrated in a piercing spike, the cartridge discharge device being designed in such a way that, when the piercing spike is in an extended position, the beverage substance can be transferred by the compressed air from the reservoir into the mixing chamber.

23. A method for preparing a beverage with a beverage preparation system as claimed in claim 19, comprising the following steps:
inserting the cartridge system, which of a cartridge and a cartridge receptacle, into the cartridge holder,
transferring the locking means from the unlocked position into the locked position;
transferring the coupling element from a retracted position into an extended position to establish a connection between the liquid line of the coupling element and a fluid supply opening (19) of the cartridge receptacle to establish a connection between a compressed air line of the coupling element and a compressed air supply opening of the cartridge receptacle;
transferring the beverage substance from the reservoir of the cartridge into the mixing chamber of the cartridge receptacle by feeding compressed air into the reservoir;
introducing a liquid into the mixing chamber of the cartridge receptacle through the coupling element; and
discharging the beverage, which is produced in the mixing chamber by mixing the beverage substance with the liquid, through the beverage outlet.

24. The method as claimed in claim 23, wherein the step of transferring the beverage substance from the reservoir of the cartridge into the mixing chamber of the cartridge receptacle comprises actuating the cartridge discharge device by transferring the piercing spike from the retracted position into the extended position, thus causing the sealing element to be perforated.

25. (canceled)
